(19) United States
(12) Patent Application Publication
(10) Pub. No.: US 2011/0103769 A1
(43) Pub. Date: May 5, 2011

(54) SECURE TIME AND SPACE SHIFTED AUDIOVISUAL WORK

(76) Inventor: Hank RISAN, Santa Cruz, CA (US)

(21) Appl. No.: 12/610,080

(22) Filed: Oct. 30, 2009

(51) Int. Cl. H04N 5/91; H04N 9/80

(52) U.S. Cl. 386/252; 386/E05.003

(57) ABSTRACT

Disclosed herein is a system and method for securely providing a time and space shifted audiovisual work. The method includes accessing a time shifted and a space shifted audiovisual work comprising a series of related images that are intrinsically intended to be shown with accompanying sounds. In addition, the time shifted and the space shifted audiovisual work is presented with a copyright compliance mechanism (CCM)-enabled playback/recording/recording application, the CCM-enabled playback/recording application utilizing a new pathway distinct from a commonly used data pathway of a audiovisual work rendering subsystem of an operating system, such that the audiovisual work continuously remains in a secure environment during rendering, playback and recording.

### FIELD

Embodiments of the present technology relates generally to the field of audiovisual works.

### BACKGROUND

Audiovisual works are works that consist of a series of related images which are intrinsically intended to be shown by the use of machines or devices such as projectors, viewers, or electronic equipment, together with accompanying sounds, if any, regardless of the nature of the material objects, such as films or tapes, in which the works are embodied.

Presently, if a user wants to buy a particular audiovisual work, the audiovisual work can be purchased and downloaded from the Internet. In many cases, the audiovisual work being purchased and downloaded will include some type of copyright protection. Basically, the copyright protection allows the owner of the copyrighted audiovisual work to control distribution of the audiovisual work and receive the proper copyright royalties for the use of the copyright protected audiovisual work. For example, if the downloaded audiovisual work is copyright protected, copyright royalties may be required by anyone copying, transmitting or subsequently downloading the protected audiovisual work.

Presently, there are a number of applications that attempt to circumvent the copyright protection. However, under Title 17, a copyright owner has legal standing to require audiovisual work distributors to protect the copyrighted material with technological measures.

### SUMMARY

Disclosed herein is a system and method for securely providing a time and space shifted audiovisual work. The method includes accessing a time shifted and a space shifted audiovisual work comprising a series of related images that are intrinsically intended to be shown with accompanying sounds. In addition, the time shifted and the space shifted audiovisual work is presented with a copyright compliance mechanism (CCM)-enabled playback/recording/recording application, the CCM-enabled playback/recording application utilizing a new pathway distinct from a commonly used data pathway of a audiovisual work rendering subsystem of an operating system, such that the audiovisual work continuously remains in a secure environment during rendering, playback and recording.

### BRIEF DESCRIPTION OF THE DRAWINGS

FIG. 1 is a block diagram of various exemplary functional components of a copyright compliance mechanism (CCM) in accordance with an embodiment of the present invention.

FIG. 2 is a block diagram of a custom audiovisual work library utilized to secure audiovisual work, in accordance with an embodiment of the present technology

FIG. 3 is a block diagram of a system for enhancing copyright revenue generation, in accordance with an embodiment of the present invention.

FIG. 4 is a block diagram of a flow chart of a method for enhancing copyright generation, in accordance with an embodiment of the present invention.

FIG. 5A is a block diagram of a system for securely providing a time and space shifted audiovisual work with online content in accordance with an embodiment of the present invention.

FIG. 5B is a block diagram of a system for securely providing a time and space shifted audiovisual work with local content in accordance with an embodiment of the present invention.

FIG. 5C is a block diagram of a system for securely providing a time and space shifted audiovisual work with a separate audio player and visual player in accordance with an embodiment of the present invention.

FIG. 6 is a flow chart of a method for securely providing a time and space shifted audiovisual work in accordance with an embodiment of the present invention.

FIG. 7 is a block diagram of an exemplary computer system in accordance with one embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

The following discussion begins with a description of a copyright compliance mechanism (CCM) and a number of embodiments for providing copyright information about an audiovisual work direct with the audiovisual work. The discussion then discusses the presentation and protection of an audiovisual work and ends with a description of a computer system upon which one or more of the discussed embodiments may be utilized, stored or input thereto.

### Copyright Compliance Mechanism

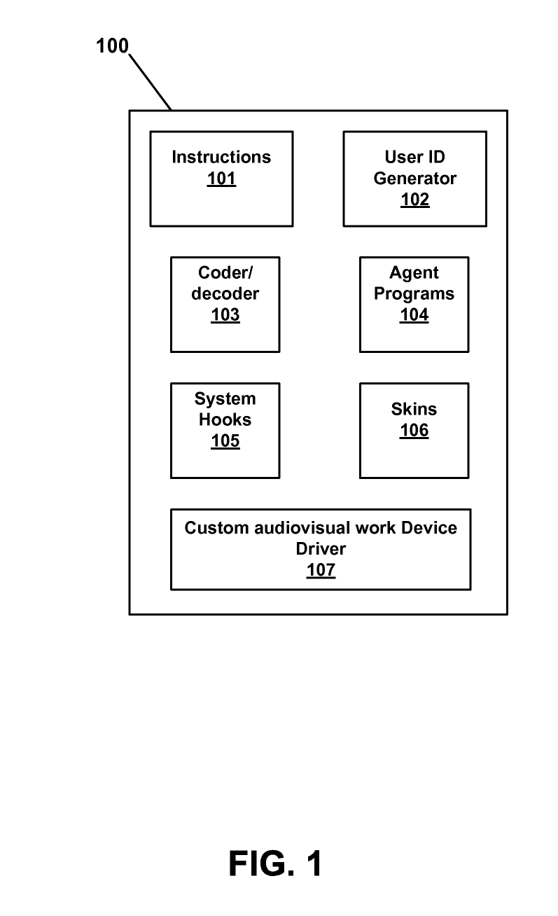

FIG. 1 is a block diagram of an exemplary copyright compliance mechanism (CCM) 100, for controlling distribution of, access to, and/or copyright compliance of audiovisual work files, in accordance with an embodiment of the present invention. In one embodiment, CCM 100 contains one or more software components and instructions for enabling compliance with DMCA (digital millennium copyright act) restrictions and/or RIAA (recording industry association of America) licensing agreements regarding audiovisual work files. In one embodiment, although copyright is used in the description, another type of usage protection including copy, transfer or playback limitations may also be utilized within the framework described herein. In other words, in one embodiment, the present technology is well suited for numerous types of usage protection including, but not limited to, copyright protection. In general, the usage protection allows the owner of the usage restricted audiovisual work to control distribution of the audiovisual work.

There are currently two types of copyright licenses recognized by the DMCA for the protection of broadcasted copyrighted material. One of the broadcast copyright licenses is a compulsory license, also referred to as a statutory license. A statutory license is defined as a non-interactive license, meaning the user cannot select the song. Further, a caveat of this type of broadcast license is that a user must not be able to select a particular music file for the purpose of recording it to the user's computer system or other storage device. Another caveat of a statutory license is that a audiovisual work file is not available more than once for a given period of time. In one example, the period of time can be three hours.

The other type of the broadcast license recognized by the DMCA is an interactive licensing agreement. An interactive licensing agreement is commonly with the copyright holder, e.g., a record company, the artist, where the copyright holder grants permission for a server to broadcast copyrighted material. Under an interactive licensing agreement, there are a variety of ways that copyrighted material, e.g., music files, can be broadcast. For example, one manner in which music files can be broadcast is to allow the user to select and listen to a particular sound recording, but without the user enabled to make a sound recording. This is commonly referred to as an interactive with “no save” license, meaning that the end user is unable to save or store the audiovisual work content file in a relatively permanent manner. Additionally, another manner in which music files can be broadcast is to allow a user to not only select and listen to a particular music file, but additionally allow the user to save that particularly music file to disc and/or burn the music file to CD, MP3 player, or other portable electronic device. This is commonly referred to as an interactive with “save” license, meaning that the end user is enabled to save, store, or burn to CD, the audiovisual work content file.

It is noted that the DMCA allows for the “perfect” reproduction of the sound recording. A perfect copy of a sound recording is a one-to-one mapping of the original sound recording into a digitized form, such that the perfect copy is virtually indistinguishable and/or has no audible differences from the original recording.

In one embodiment, CCM 100 is installed into each client computer system. Alternatively, CCM 100 can be, in another embodiment, externally disposed and communicatively coupled with a client computer system. In one embodiment, portions of components, entire components and/or combinations of components of CCM 100 can be readily updated to reflect changes or developments in the DMCA, changes or developments in copyright restrictions and/or licensing agreements that pertain to any audiovisual work file, changes in current audiovisual work player applications and/or the development of new audiovisual work player applications.

Referring to FIG. 1, in one embodiment, CCM 100 is shown to include instructions 101 for enabling a client computer system to interact with a web server or content server on a network. CCM 100 also includes, a user ID generator 102, for generating a user ID or user key, and one or more cookie(s) which contain(s) information specific to the user and the user's computer system. In one embodiment, the presence of a valid cookie(s) and a valid user ID/user key are verified by a web server before the remaining components of a CCM 100 can be installed. Additionally, the user ID/user key can contain, but is not limited to, the user's name, the user's address, the user's credit card number, verified email address, and an identity (username) and password selected by the user. Furthermore, the cookie can contain, but is not limited to, information specific to the user, information regarding the user's computer system, e.g., audiovisual work applications thereon, a unique identifier such as a MAC (machine address code) address and/or an IP address, and other information specific to the user and the computer system operated by the user. The information regarding the client computer system, the user of the system, and an access key described herein can be collectively referred to as authorization data.

Advantageously, with information regarding the user and the user's computer system, a web server can determine when a user of one computer system has given their username and password to another user using another computer system. If the web server detects unauthorized sharing of usernames and passwords, it can block the computer system from future access to copyrighted audiovisual work content available through the web server for any specified period of time, e.g., for a matter of minutes or hours to months, years, or longer.

Still referring to FIG. 1, CCM 100 further includes one or more coder/decoders (codec) 103 that, in one embodiment, is/are adapted to perform, but is/are not limited to, encoding/decoding of audiovisual work files, compressing/decompressing of audiovisual work files, detecting that delivered audiovisual work files are encrypted as prescribed by CCM 100. In the present embodiment, coder/decoder 103 can also extract key fields from a header attached to each audiovisual work content file for, in part, verification of the audiovisual work file. In one embodiment, codec 103 can also perform a periodic and repeated check of the audiovisual work file, while the audiovisual work file is passed to the audiovisual work player application, e.g., in a frame by frame basis or in a buffer by buffer basis, to ensure that CCM 100 rules are being enforced at any particular moment during audiovisual work playback. It is noted that differing codec 103 can be utilized in conjunction with various types of copyrighted audiovisual work content including, but not limited to, audio files, video files, graphical files, alphanumeric files and the like, such that any type of audiovisual work content file can be protected in accordance with embodiments of the present invention.

With reference still to FIG. 1, CCM 100 also includes one or more agent programs 104 which are configured to engage in dialogs and negotiate and coordinate transfer of information between a computer system, a server, and/or audiovisual work player applications, with or without recording functionality, that are operable within a client computer system. In addition, agent program 104 can be configured to maintain system state, verify that other components are being utilized simultaneously, to be autonomously functional without knowledge of the client, and can also present messages, e.g., error messages, audiovisual work information, advertising, etc., via a display window or electronic mail. This enables detection of proper skin implementation and detection of those applications that are running. It is noted that agent programs are well known in the art and can be implemented in a variety of ways in accordance with the present embodiment.

CCM 100 also includes one or more system hooks 105. A system hook 105 is, in one embodiment, a library that is installed in a computer system and intercepts system wide events. For example, a system hook 105, in conjunction with skins 106, can govern certain properties and/or functionalities of audiovisual work player applications operating within the client computer system, including, but not limited to, mouse click shortcuts, keyboard shortcuts, standard system accelerators, progress bars, save functions, pause functions, rewind functions, skip track functions, forward track preview, copying to CD, copying to a portable electronic device, and the like.

It is noted that the term governing, can refer to a disabling, deactivating, enabling, activating, etc., of a property or function. Governing can also refer to an exclusion of that function or property, such that a function or property may be operable but unable to perform in the manner originally intended. For example, during playing of a audiovisual work file, the progress bar may be selected and moved from one location on the progress line to another without having an effect on the play of the audiovisual work file.

In one embodiment, system hook 105 compares the information for the audiovisual work player application operating in client computer system with a list of “signatures” associated with known audiovisual work recording applications. In one embodiment, the signature can be, but is not limited to being, a unique identifier of a audiovisual work player application and which can consist of the window class of the application along with a product name string which is part of the window title for the application. Advantageously, when new audiovisual work player applications are developed, their signatures can be readily added to the signature list via an update of CCM 100 described herein.

The following C++ source code is exemplary implementation of the portion of a system hook 105 for performing audiovisual work player application detection, in accordance with an embodiment of the present invention.

```
int
IsRecorderPresent(TCHAR * szAppClass,
      TCHAR * szProdName)
{
  TCHAR  szWndText[_MAX_PATH]; /* buffer to receive title string for
window */
  HWND  hWnd;  /* handle to target window for operation */
  int  nRetVal;  /* return value for operation */
  /* initialize variables */
  nRetVal = 0;
  if ( _tcscmp(szAppClass,_T(“#32770”))
    == 0)
  {
      /* attempt to locate dialog box with specified window title */
      if ( FindWindow((TCHAR *) 32770, szProdName)
        != (HWND) 0)
      {
          /* indicate application found */
          nRetVal = 1;
      }
  }
  else
  {
      /* attempt to locate window with specified class */
      if ( (hWnd = FindWindow(szAppClass, (LPCTSTR) 0))
        != (HWND) 0)
      {
          /* attempt to retrive title string for window */
          if ( GetWindowText(hWnd,
              szWndText,
              _MAX_PATH)
        != 0)
      {
          /* attempt to locate product name within title string */
          if ( _tcsstr(szWndText, szProdName)
            != (TCHAR *) 0)
          {
              /* indicate application found */
              nRetVal = 1;
          }
      }
    }
  }
  /* return to caller */
  return nRetVal;
}
```

In one embodiment, system hook 105 can also selectively suppress waveform input/output operations to prevent recording of copyrighted audiovisual work on a client computer system. For example, system hook 105, subsequent to detection of bundled audiovisual work player applications operational in a client computer system can stop or disrupt the playing of a audiovisual work content file. This can be accomplished, in one embodiment, by redirecting and/or diverting certain data pathways that are commonly used for recording, such that the utilized data pathway is governed by CCM 100. This can be performed within a driver shim for a standard operating system waveform output device. Moreover, the driver shim may be configured to appear as the default waveform audio device to client level application programs. Thus, requests for processing of waveform audio input and/or output will pass through the driver shim prior to being forwarded to the actual waveform audio driver. Such waveform input/output suppression can be triggered by other components of CCM 100, e.g., agent 104, to be active when a recording operation is initiated by a client computer system during the play back of audiovisual work files which are subject to the DMCA. The driver shim can be implemented for nearly any audiovisual work in nearly any format including, but not limited to, audio audiovisual work files and audio input and output devices.

The following C++ source code is an exemplary implementation of the portion of a system hook 105 for diverting and/or redirecting certain data pathways that are commonly used for recording of audiovisual work content, in accordance with an embodiment of the present invention.

```
DWORD
_stdcall
widMessage(UINT uDevId,
  UINT uMsg,
  DWORD  dwUser,
  DWORD dwParam1,
  DWORD dwParam2)
{
  BOOL bSkip;  /* flag indicating operation to be skipped */
  HWND hWndMon; /* handle to main window for monitor */
  DWORD dwRetVal; /* return value for operation */
  /* initialize variables */
  bSkip = FALSE;
  dwRetVal = (DWORD) MMSYSERR_NOTSUPPORTED;
  if (uMsg == WIDM_START)
  {
    /* attempt to locate window for monitor application */
    if ( (hWndMon = FindMonitorWindow( ))
      != (HWND) 0)
    {
        /* obtain setting for driver */
        bDrvEnabled = ( SendMessage(hWndMon,
              uiRegMsg,
                0,
                0)
            == 0)
          ? FALSE : TRUE;
    }
    if (bDrvEnabled == TRUE)
    {
        /* indicate error in operation */
        dwRetVal = MMSYSERR_NOMEM;
        /* indicate operation to be skipped */
        bSkip = TRUE;
    }
  }
  if (bSkip == FALSE)
  {
    /* invoke entry point for original driver */
    dwRetVal = CallWidMessage(uDevId, uMsg, dwUser, dwParam1,
dwParam2);
  }
  /* return to caller */
  return dwRetVal;
}
```

When properly configured, system hook 105 can govern nearly any function or property within nearly any audiovisual work player application that may be operational within a client computer system. In one embodiment, system hook 105 is a DLL (dynamic link library) file. It is further noted that system hooks can be implemented in nearly any operating system.

In FIG. 1, CCM 100 also includes one or more skins 106, designed to be installed in a client computer system. In one embodiment, skins 106 are utilized to assist in client side compliance with the DMCA regarding copyrighted audiovisual work content. Skins 106 are customizable interfaces that, in one embodiment, are displayed on a display device of computer system and provide functionalities for user interaction of delivered audiovisual work content. Additionally, skins 106 can also provide a display of information relative to the audiovisual work content file including, but not limited to, song title, artist name, album title, artist bio, and other features such as purchase inquiries, advertising, and the like.

Furthermore, when system hook 105 is unable to govern a function of the audiovisual work player application operable on a client computer system such that client computer system could be in non-compliance with DMCA and/or RIAA restrictions, a skin 106 can be implemented to provide compliance.

Differing skins 106 can be implemented depending upon the DMCA and/or RIAA restrictions applicable to each audiovisual work content file. For example, in one embodiment, a skin 106 may be configured for utilization with a audiovisual work content file protected under a non-interactive agreement and may not include a pause function, a stop function, a selector function, and/or a save function, etc. In another embodiment, skin 106 may be configured to be utilized with a audiovisual work content file protected under an interactive “no save” agreement such that skin 106 may include a pause function, a stop function, a selector function, and for those audiovisual work files having an interactive with “save” agreement, a save or a burn to CD function.

Still referring to FIG. 1, each skin 106 can have a unique name and signature and can be implemented, in part, through the utilization of an MD (message digest) 5 hash table or similar algorithm. An MD 5 hash table can be, in one implementation, a check-sum algorithm. Since modification of the skin would change the check sum and/or MD 5 hash, without knowledge of the MD 5 hash table, changing the name or modification of the skin may simply serve to disable the skin, in accordance with one embodiment of the present invention. Since CCM 100 verifies skin 106, MD5 hash tables advantageously provide a deterrent against skin name changes and/or modifications made thereto.

In one embodiment, CCM 100 also includes one or more custom audiovisual work device driver(s) 107 for providing an even greater measure of control over the audiovisual work stream while increasing compliance reliability. A client computer system is configured to utilize a custom audiovisual work device application, e.g., a custom audio device application, a custom video device application, etc., that is emulated by a custom audiovisual work device driver 107. With reference to audio audiovisual work, the emulation is performed in a waveform audio driver associated with a custom audio device. Driver 107 is configured to receive a audiovisual work file being outputted by the system prior to the audiovisual work file being sent to a audiovisual work output device, e.g., a video card for video files or a sound card for audio files, etc. In one embodiment, client computer system is configured with a custom audiovisual work device driver 107 as the default device driver for audiovisual work file output. In one embodiment, an existing GUI (graphical user interface) can be utilized or a GUI can be provided, e.g., by utilization of a skin 106 or a custom web based player application, for forcing or requiring the system to have driver 107 as the default driver.

Therefore, when a audiovisual work content file is received by the system, the audiovisual work content file is playable, provided the audiovisual work content file passes through the custom audiovisual work device application, emulated by custom audiovisual work device driver 107, prior to being outputted. However, if an alternative audiovisual work player application is selected, delivered audiovisual work files will not play on the system.

Thus, secured audiovisual work player applications would issue a audiovisual work request to the driver for the custom audiovisual work device which then performs necessary audiovisual work input suppression, e.g., waveform suppression for audio files, prior to forwarding the request to the default waveform audio driver for audio files.

It is noted that requests for non-restricted audiovisual work files can pass directly through custom audiovisual work device driver 107 to a waveform audio driver operable on the system. It is further noted that for either secured audiovisual work or non-restricted audiovisual work, e.g., audio audiovisual work files, waveform input suppression can be triggered by other components of CCM 100, e.g., agents 104, system hooks 105, and skins 106, or a combination thereof, to be active when a recording operation is initiated simultaneously with playback of secured audiovisual work files.

Advantageously, by virtue of being configured with a custom audiovisual work device, emulated by a custom audiovisual work device driver 107, as the default device driver, those audiovisual work player applications that require their particular device driver to be the default driver, e.g., Total Recorder, etc., are rendered non-functional for secured music. Further advantageous is that an emulated custom audiovisual work device provides no native support for those audiovisual work player applications used as a recording mechanism, e.g., DirectSound capture, etc., that are able to bypass user-mode drivers for most audiovisual work devices. Additionally, by virtue of the audiovisual work content being sent through device driver 107, thus effectively disabling unauthorized saving/recording of the audiovisual work files; audiovisual work files that are delivered in a secured delivery system do not have to be encrypted to provide compliance with copyright restrictions and/or licensing agreements, although, in another embodiment, they still may be encrypted.

### Custom Audiovisual Work Library

A subversive and illegal technique for capturing outgoing copyright audiovisual work data is addressed and overcome herein. Specifically, the present technology stops a copyright-disregarding recording application from establishing a system hook for the purpose of generating an illegal copy of the copyright audiovisual work. That is, the present technology redirects calls made by secure audiovisual work playback applications to unsecure standard operating system services used for rendering the raw audiovisual work data. In so doing, the system hook is no longer able to intercept the raw audiovisual work data and therefore no longer able to deliver the intercepted data to illicit recording application 290.

Additionally, since the present technology implements a custom audiovisual work library utilizing a new pathway at the CCM-enabled playback/recording application to circumvent the illegal copying techniques without interfering or disrupting the commonly used pathway, the computer system maintains the capability of delivering audiovisual work content that may be legally copied to the recording application while protecting copyrighted audiovisual work from being illegally copied by the same, or another, recording application.

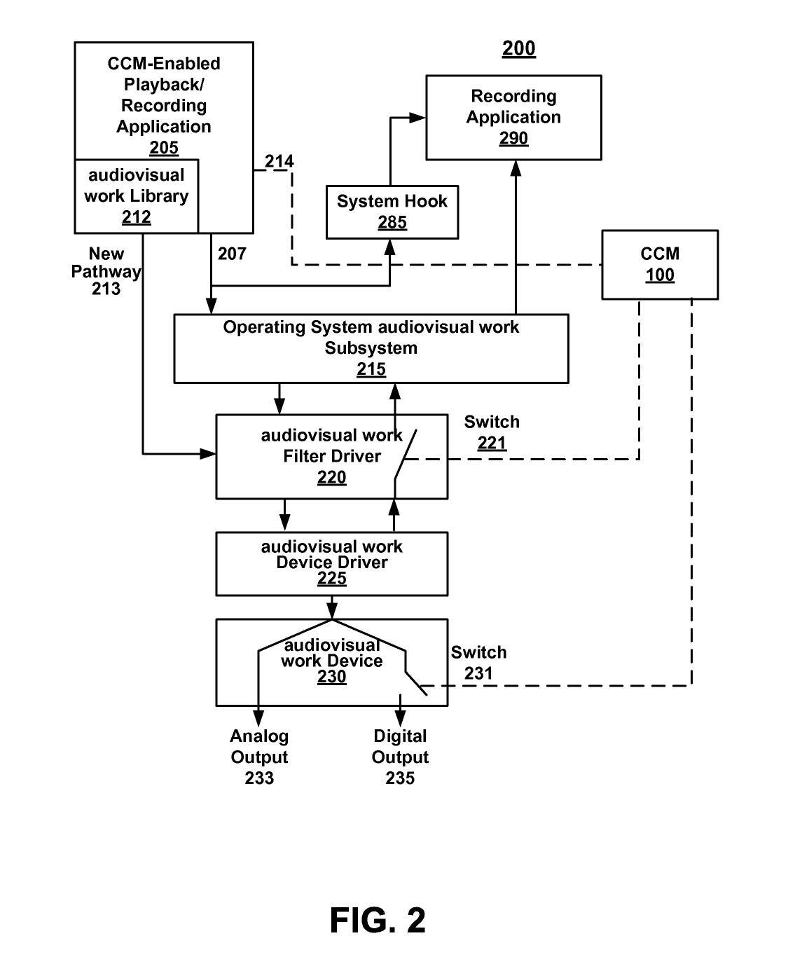

With reference now to FIG. 2, a block diagram of a computer system 200 having a custom audiovisual work library to secure audiovisual work is shown in accordance with an embodiment of the present technology. In one embodiment, FIG. 2 includes a number of distinct components and devices for clarity in the discussion. However, in another embodiment, more or fewer components and devices may be present. Further, in yet another embodiment, the components and devices may be combined into one or more components able to perform a number of the actions shown in FIG. 2.

In one embodiment, by utilizing the audiovisual work library 212 in conjunction with the CCM-enabled playback/recording application 205 and the CCM 100, secure audiovisual work content may be rendered, played, recorded and copied without the data being in an unsecure environment. In addition, due to the secure environment, in one embodiment no encryption of the audiovisual work content is necessary.

For example, as illustrated in FIG. 2, when a hooked system service, e.g., OS audiovisual work subsystem 215, is called, the system hook 285 will gain control of the commonly used pathway 207 first, allowing the recording application 290 to perform application-specific processing before passing control to the actual OS audiovisual work subsystem 215. The system hook 285 will thus allow the recording application 290 to capture output data without the use of a virtual audiovisual work device driver or plug-in module.

However, embodiments described herein, overcome this illegal capture technique by incorporating a audiovisual work library 212 of audiovisual work functions that make use of lower-level components in the audiovisual work subsystem, e.g., audiovisual work filter driver 220, to render secure audiovisual work data. These lower-level components are not affected by the system hooks 285 that are used by recording applications, and thus copyright protected audiovisual work can pass securely from the CCM-enabled playback/recording application 205 to a part of the audiovisual work subsystem, e.g., the audiovisual work filter driver 220 that is protected by the existing CCM, e.g., CCM 100.

For example, in one embodiment, custom audiovisual work library 212 provides a secure path for the audiovisual work as it is delivered from the CCM-enabled playback/recording application 205 to the operating system (OS) audiovisual work subsystem 215. In one embodiment, audiovisual work library 212 is able to securely receive the audiovisual work from the CCM-enabled playback/recording application 205 because it is linked directly into the CCM-enabled playback/recording application 205. That is, audiovisual work library 212 is not a dll and is not implemented as a standalone object. In other words, because audiovisual work library 212 is linked directly into the CCM-enabled playback/recording application 205, a system hook 285 is not able to hook audiovisual work as it is passed from the CCM-enabled playback/recording application 205 to the audiovisual work library 212.

In addition, in one embodiment, the audiovisual work library 212 operates below both the kernel mode and the driver level. As such, during the transmission of the digital audiovisual work from the audiovisual work library 212 to the audiovisual work filter driver 220 via new pathway 213, there is no unsecure kernel mode or driver level mode pathways for system hook 285 to “hook”.

For example, instead of using the commonly used pathway 207 to deliver copyright protected audiovisual work content, such as raw wave data, to an OS audiovisual work subsystem 215 for rendering, the CCM-enabled playback/recording application 205 will utilize custom audiovisual work library 212 to generate a new pathway 213 and deliver the raw wave data directly to the audiovisual work filter driver 220. In other words, in one embodiment, the utilization of audiovisual work library 212 will provide more general control over the audiovisual work stream while increasing compatibility and reliability of the overall solution. For example, audiovisual work library 212 would involve the configuration of new pathway 213 within the computer system 200 to securely deliver the audiovisual work to a audiovisual work filter driver 220 at the kernel level.

At the same time, the CCM-enabled playback/recording application 205 will inform CCM 100, via communication pathway 214, that copyright protected raw data will be received at audiovisual work filter driver 220 and that protection is to be enabled at the kernel mode. As described herein, the CCM 100 is able to protect the copyright protected audiovisual work by, in one embodiment, instructing the audiovisual work device driver 225, via switch 221, to suppress waveform input operations. Moreover, in some cases, the CCM 100 may also instruct audiovisual work device 230, via switch 231, to suppress waveform output operations such as digital output 235.

Thus, in one embodiment, controlled audiovisual work directed for rendering at the OS audiovisual work subsystem 215 will first pass securely from the secure CCM-enabled playback/recording application 205 to the audiovisual work filter driver 220 and then remain secure during rendering by CCM 100.

In one embodiment, requests for non-secure audiovisual work traffic would also be controlled by audiovisual work library 212 utilizing the new pathway 213. However, in another embodiment, requests for non-secure audiovisual work traffic may pass directly from the CCM-enabled playback/recording application 205 to the OS audiovisual work subsystem 215 via the commonly used pathway 207. When passing the audiovisual work directly from the CCM-enabled playback/recording application 205 to the OS audiovisual work subsystem 215 via the commonly used pathway 207, the audiovisual work would be susceptible to system hook 285 and recording application 290. Of course, since the audiovisual work utilizing the commonly used pathway 207 is uncontrolled, utilizing the system hook 285 in an attempt to obtain a subversive copy of the audiovisual work would be immaterial since the audiovisual work may be legally copied.

In another embodiment, for audiovisual work devices 230 that support “standard” streaming at the kernel level, the OS audiovisual work subsystem 215 may issue a request to the audiovisual work device 230 for each block of data to be read for a capture operation. In one embodiment, if the audiovisual work is controlled, the CCM 100 can intercept each request, such as at switch 221 and control the content in the data buffer that is returned to the OS audiovisual work subsystem 215. As stated herein, the CCM 100 control can include (but is not necessarily limited to) the muting of the waveform data, and the introduction of distortion into the audiovisual work stream.

For audiovisual work devices 230 that either support “looped” streaming or the WaveRT port type, the OS audiovisual work subsystem 215 may issue one or more requests at the start of the capture operation to either provide the location of the application-specific audiovisual work buffer to be used for the operation or obtain the address of the driver-provided capture buffer. The OS audiovisual work subsystem 215 will then pass data directly to the recording application 290 using these buffers, and thus the CCM 100 will be unable to monitor the data stream during the capture operation. In one embodiment, to prevent unauthorized recording for audiovisual work devices 230 supporting these techniques, the CCM 100 will instruct the audiovisual work device 230 to stop the capture operation at switch 221 and/or switch 231. If the recording application 290 or OS audiovisual work subsystem 215 attempts to subsequently restart the capture, the CCM 100 will detect the restart request and prevent the request from being serviced by the audiovisual work device 230.

For the purpose of clarification, “standard” streaming is the technique where multiple data buffers are used to stream audio data, with the kernel acting upon one buffer at a time. “Looped” streaming uses a single shared buffer, with the client and the kernel acting upon different regions within the buffer. “WaveRT” uses a mechanism similar to looped streaming, except that the buffer is allocated and managed by the audio device rather than the kernel.

As described herein, the CCM 100 will monitor the system 200 for unauthorized capture operations. Upon detection of such operations, CCM 100 can respond by continuing to allow playback of secure audiovisual work data while controlling audiovisual work capture, or to control the playback of the audiovisual work data. This control can include (but is not necessarily limited to) the muting of waveform input or output, and the introduction of distortion into the audiovisual work stream.

Thus, by utilizing the technology described herein, that is, the secure delivery of copyright protected audiovisual work via the audiovisual work library 212 using the user mode new pathway 213 and the CCM 100, unsecure OS audiovisual work subsystem 215 is bypassed and the audiovisual work is passed to lower level audiovisual work components, such as audiovisual work filter driver 220, protected by the CCM 100. Then, when the copyright protected audiovisual work is then passed from the audiovisual work filter driver 220 to the OS audiovisual work subsystem 215 for rendering, it is already protected by the CCM 100 and the previously utilized direct sound pirate system hook 285 will no longer be able to access the audiovisual work.

In other words, the copyright protected audiovisual work remains in a secure environment the entire time it is on the computer system 200. Because the computer system 200 provides a secure environment for the copyright protected audiovisual work, in one embodiment no additional measures, such as encryption, or the like on any or all of the copyright protected audiovisual work are necessary for ensuring copyright compliance.

### Royalty Collection

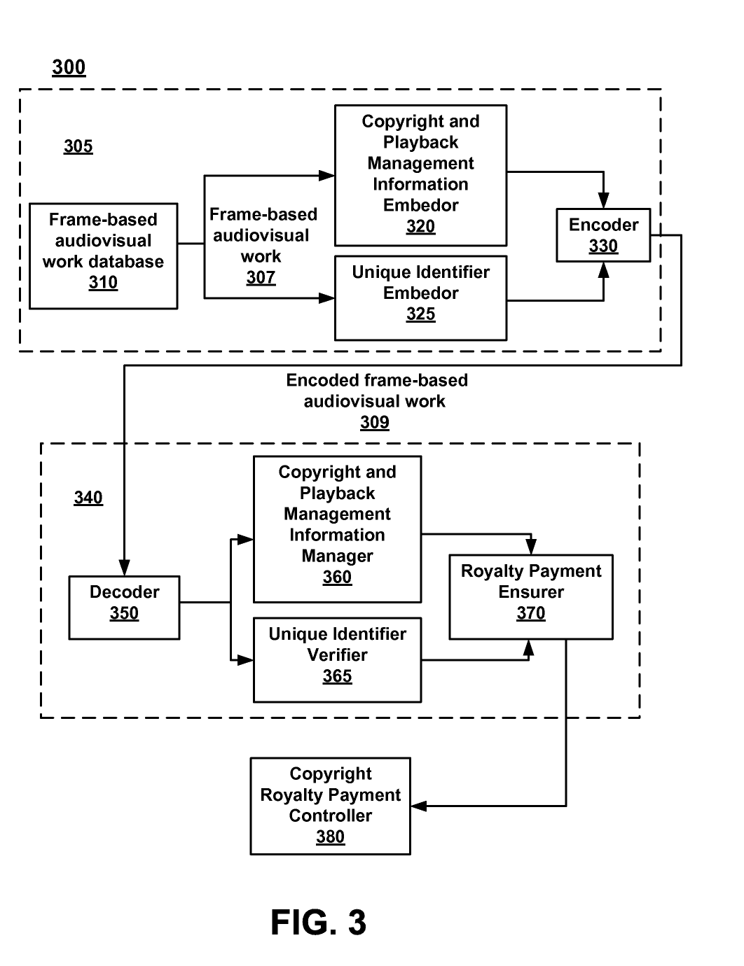

An audiovisual work provider, such as a audiovisual work web broadcaster, that provides a large database of audiovisual work, such as but not limited to sound recordings, may transmit large volumes of copyrighted audiovisual work and may be required to pay large amounts of royalty fees. An embodiment in accordance with the present invention provides a system 300 for enhancing copyright revenue generation, as illustrated in FIG. 3. System 300 includes a system 305, a device 340 and a copyright royalty payment controller 380. The system 305 includes a frame-based audiovisual work database 310, a copyright and playback management information embedor 320, a unique identifier embedor 325 and an encoder 330.

The system 305 facilitates in the enhancing of copyright revenue generation by facilitating in the ensuring of appropriate payment of entitled copyright royalties. In one embodiment, the system 305 is a web broadcaster that broadcasts audiovisual work via the Internet. It should be appreciated that the audiovisual work is any frame-based audiovisual work 307 which is stored in a frame-based audiovisual work database 310. In one embodiment, the frame-based audiovisual work 307 are MPEG-1 Audio Layer 3 (MP3) files intrinsically associated with an accompanying series of related images.

In one embodiment, the system 305 facilitates the ensuring of appropriate payment of entitled copyright royalties of copyright works by introducing technological measures to the a copyright protected frame-based audiovisual work 307 by way of copyright and playback management information embedor 320. In another embodiment, the system 305 facilitates the ensuring of appropriate payment of entitled copyright royalties of copyright works by introducing technological measures to the copyright protected frame-based audiovisual work 307 by way of unique identifier embedor 325.

It should be appreciated that the copyright and playback management information can be but is not limited to a SCMS. SCMS is a scheme to protect copyrights of digital productions by preventing data from being repeatedly copied. SCMS is built into a audiovisual work appliance which has a function to create a copy of digital data, such as an MP3 file. The audiovisual work appliance with the SCMS built into it can prevent a first-generation copy recorded by the user from being copied again. In other words, the SCMS prevents a second or higher generation copy from being created.

Copyright and playback management information embedor 320 embeds copyright and playback management information within frame-based audiovisual work 307. It should be appreciated that the copyright and playback management information is any information related to the management and/or the enforcement of copyright protection associated with a copyright protected work. In various embodiments, the copyright and playback management information can be but is not limited to the number of copies allowed of the frame-based audiovisual work, the number of copies allowed of the frame-based audiovisual work, version number of the frame-based audiovisual work or no copies allowed, rules for subsequent copies and the like, as well as the number of plays allowed of the frame-based audiovisual work and the types of devices that are allowed to play the audiovisual work.

In one embodiment, the copyright management information indicates which machine, product and/or company the copyright protected work came from and/or is allowed to be played back on. It should also be appreciated that the copyright management information may be forensics related information, such as but not limited to tracking information. Further, in one embodiment, the copyright management information is an expiration date(s) associated with the copyright protected work.

It should be appreciated that the copyright and playback management information embedor 320 embeds copyright and playback management information within at least one data field of the frame-based audiovisual work 307. In one embodiment, the data field is an application-private bit of a MP3 file. Typically, MP3 files are segmented into thousands of frames. For example, a three to five minute song can have approximately 8,000 to 12,000 frames. Each frame contains a fraction of a second's worth of audio data. At the beginning of every data frame is a header frame which stores 32 bits of meta-data related to the coming data frame. The MP3 header begins with a sync block that consists of 11 bits. The sync block allows players to search for and lock onto the first available occurrence of a valid frame. Following the sync block are a plurality of other header blocks that facilitate in the proper decoding and subsequent playing of the MP3 file. One of the other header blocks is the application-private bit, which allows for application-specific triggers. For example, if there are 8,000 frames in an MP3 file, there is a private bit corresponding to each frame for a total of 8,000 private bits.

In one embodiment, the copyright and playback management information is a multiple bit data structure using the application-private bits in the MP3 frame headers across consecutive audio frames. For example, if the copyright and playback management information contains 32 bits, then each bit is stored in 32 consecutive application-private bits in corresponding 32 consecutive frames. In particular, the first bit of the copyright and playback management information is stored in the application-private bit of the header for the first audio frame. The second bit of the copyright and playback management information is stored in the application-private bit of the second audio frame and so on until all the data in the copyright and playback management information is stored in consecutive frames.

Further, the sequence of bits associated with the copyright and playback management information data block is continuously repeated throughout the entire audio file. Once the entire data block has been encoded, the first bit of the copyright and playback management information data block is stored in the application-private bit of the header for the next frame within the MP3 file. Accordingly, the playback application is able to detect the copyright and playback management information for the audio file irrespective of the starting position within the file from which the playback was initiated. For example, if the MP3 file has 8,000 frames and a corresponding 8,000 application private bits, then a copyright and playback management information data block of 32 bits is initially stored in the first 32 consecutive application-private bits and repeatedly stored in consecutive application-private bits, for a total of 250 consecutive and repeated instances of the copyright and playback management information data block stored in the entire MP3 file.

In one embodiment, the copyright and playback management information (CMI) is a 32-bit data structure having the following format. It should be appreciated that the 32-bit data structure is a SCMS data structure used to encode playback rights information in addition to copy control information. For example, a copyright holder may choose to allow a particular work to be played freely a certain number of times before requiring a license key or other access mechanism.

Elements of the 32-bit data structure are shown in Table 1:

| Offset | Description |
|---|---|
| 0 | First byte of CMI, set to fixed value to facilitate detection by a |
| | playback or secure copy/playback application |
| 8 | Second byte of CMI, set to fixed value to facilitate detection by |
| | a playback or secure copy application |
| 16 | Version number of CMI (three binary bits) |
| 19 | Flag indicating copying not allowed for audiovisual work file |
| 20 | If bit at offset 19 is not set, number of copies allowed for file |
| | (up to a maximum of 15). A value binary 0000 indicates that the |
| | file may be freely copied. |
| 24 | Number of plays allowed for file (up to a maximum of 255). If |
| | this field is set to binary 00000000, the file can be freely played. |

Additional security is available by using an encryption mechanism. Specifically, an encoder generates one or more sequences of data bytes to be used as keys for the encoding of the audiovisual work data for the file. The key sequences can be derived from a cryptographically secure digest taken across all or part of the data for the file. Thus, the key sequences are most likely different for each audiovisual work file.

The key sequences that are used for the encryption for all or part of the SCMS data block are unique to each copyright protected work. The key sequences can be generated using data from the copyright protected work. Thus the SCMS data block can be used to help ensure the integrity and authenticity of the copyright protected work.

It should be appreciated that to allow playback devices to more easily detect the presence of copyright and playback management information, the two marker bytes for each copyright and playback management information data block can be left unencoded.

In one embodiment, system 305 facilitates in the ensuring of appropriate payment of entitled copyright royalties of the copyright protected frame-based audiovisual work 307 by adding technological measures to the frame-based audiovisual work via unique identifier embedor 325. Unique identifier embedor 325 embeds at least one unique identifier into a frame-based audiovisual work file. In one embodiment, the at least one unique identifier is invariant and is embedded into metadata, such as but not limited to an ID3V2 tag. Further, in one embodiment, at least one unique identifier may be a valid copyright registration number from the United States Copyright Office associated with copyright protected frame-based audiovisual work 307. In another embodiment, at least two copyright registration numbers are embedded into ID3V2 tags of an MP3 file.

System 305 encodes the frame-based audiovisual work subsequent to the copyright and playback management information embedor 320 embedding copyright and playback management information into the frame-based audiovisual work 307 and/or the unique identifier embedor 325 embedding at least one unique identifier into the frame-based audiovisual work 307.

Transcoding can be performed on a frame-based audiovisual work that results in frameless audiovisual work. For example, an MP3 file can be transcoded into another format (e.g., way, AC3), such that it loses its frames, header, footer and as a result all that is left are the payloads. In a frameless audiovisual work file, the copyright and playback information can be encoded by selecting a certain frequency not usually perceived by the listener and then changing its value to reflect the copyright and playback information data. For example, if a low frequency is selected and sampled, such that there is a guaranteed match on a significant pattern, the copyright and playback information can be further read for copyright and playback rules.

Audiovisual work device 340 includes a decoder 350 that decodes the encoded frame-based audiovisual work 309, copyright and playback management information manager 360, unique identifier verifier 365 and royalty payment ensurer 370. Copyright and playback management information manager 360 manages the frame-based audiovisual work 307 according to the copyright and playback information that is embedded into the frame-based audiovisual work.

Unique identifier verifier 365 verifies that the at least one unique identifier embedded in the decoded frame-based audiovisual work is the same unique at least one unique identifier that was embedded into the frame-based audiovisual work 307. In one embodiment, unique identifier verifier 365 verifies that the two copyright registration numbers associated with the MP3 file embedded in the ID3V2 tags of an MP3 file are the same two copyright registration numbers associated with the MP3 file embedded in the ID3V2 tags subsequent decoding of the MP3 file in the device 340. It should be appreciated that if the unique identifier verifier 365 determines that the at least one unique identifier decoded at device 340 is the same as the at least one unique identifier that was embedded into the frame-based audiovisual work 307, then it helps determine that the decoded frame-based audiovisual work 307 has not been tampered with and is not a counterfeit. It should also be appreciated that the ID3V2 tags are metadata in the MP3 frame headers, as described above.

In one embodiment, the royalty payment ensurer 370 facilitates in ensuring appropriate payment of entitled copyright royalties of the copyright protected frame-based work 307 based at least in part on the embedded copyright and playback management information. In another embodiment, the royalty payment ensurer 370 facilitates in ensuring appropriate payment of entitled copyright royalties of the copyright protected frame-based work 307 based at least in part on the embedded at least one unique identifier. Typically, the copyright owner of a copyright protected work is entitled to copyright royalties upon the transmission of a frame-based audiovisual work 307. Based at least in part upon the output of the copyright management information manager 360 and the unique identifier verifier 366, the copyright owner of the frame-based audiovisual work is ensured appropriate payment of entitled royalties.

The copyright royalty payment controller 380 receives information from the device 340 and pays the copyright owner of the copyright protected work for the use of the copyright protected work accordingly. It should be appreciated that the copyright royalty payment controller 380 can be but is not limited to a performing rights organization (e.g., The American Society of Composers, Authors and Publishers, Broadcast Music, Inc., SESAC, Inc. and SoundExchange) and/or mechanical rights agency (e.g., Harry Fox Agency and Canadian Mechanical Rights Reproduction Agency).

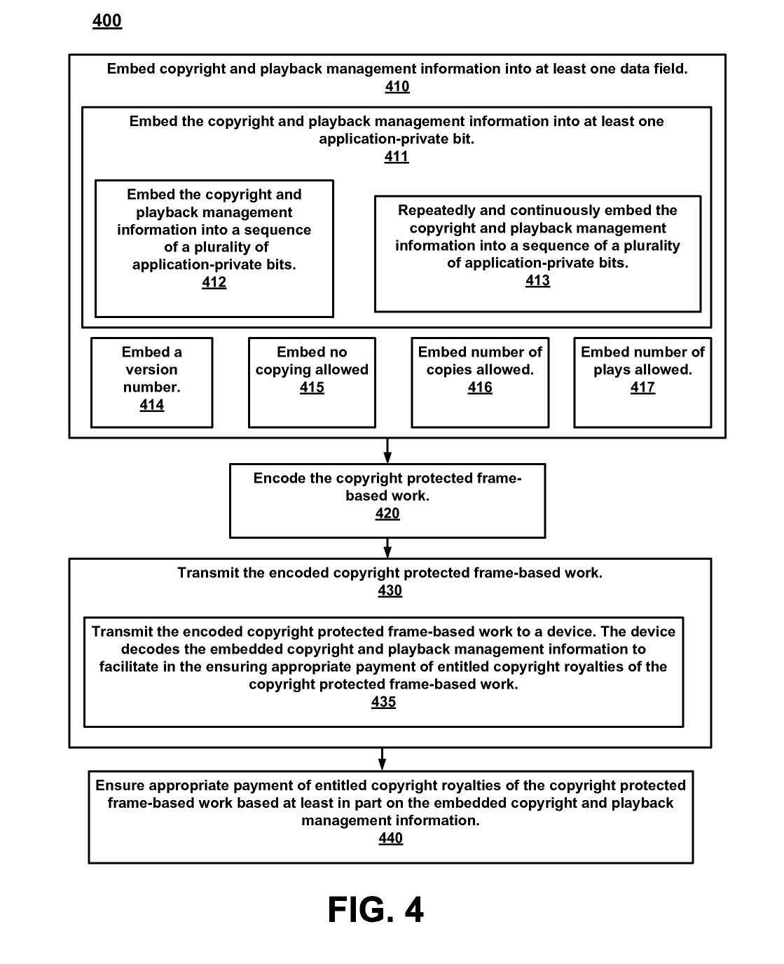

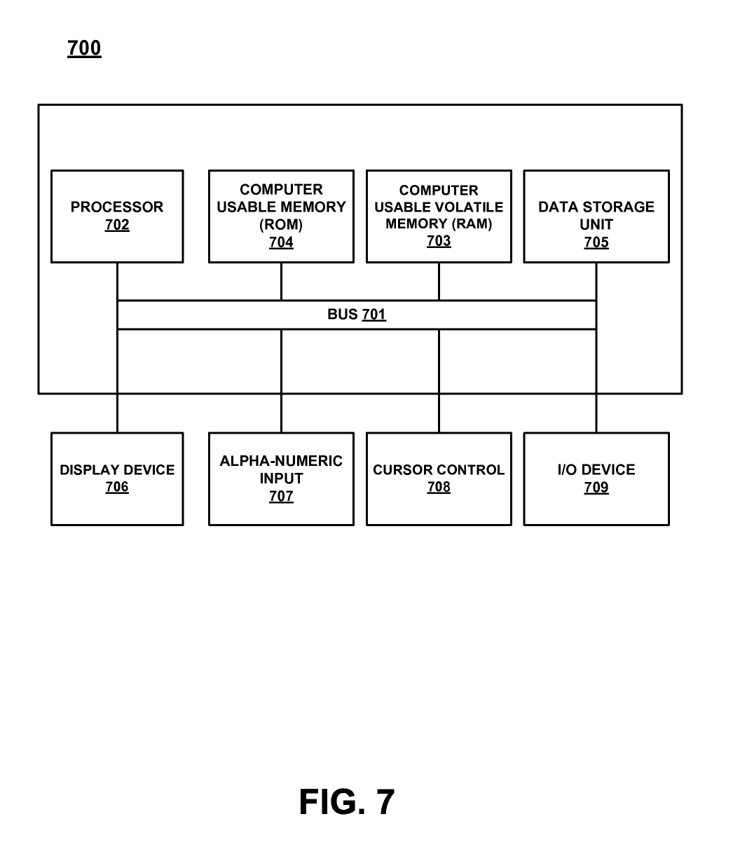

FIG. 4 is a flowchart illustrating a process 400 for enhancing copyright revenue generation. In one embodiment, process 400 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In one embodiment, process 400 is performed at least by system 700 of FIG. 7.

At block 410 of FIG. 4, copyright and playback management information is embedded into at least one data field of the copyright protected frame-based work. The copyright and playback management information corresponds to access to the copyright protected frame-based work. In one embodiment, at block 411, the copyright and playback management information is embedded into at least one application-private bit of at least one corresponding frame of a MP3 file. In another embodiment, at block 412, the copyright and playback management information is embedded into a sequence of a plurality of application-private bits. In another embodiment, at block 413, the copyright and playback management information is repeatedly and continuously embedded into a sequence of a plurality of application-private bits.

In another embodiment, at least two unique identifiers are embedded into at least two data fields of the copyright protected frame-based work. The embedding of the at least two unique identifiers corresponding to access to the copyright protected frame-based work. For example, the at least two unique identifiers may be embedded into an ID3V2 tag of at least one corresponding frame of a MP3 file. In another embodiment, a copyright registration number for an underlining sound recording and/or an underlining composition corresponding to the copyright protected frame-based work is embedded into the frame-based work.

In yet another embodiment, an audio frequency is selected that is not usually perceived by a listener of the copyright protected work. The copyright protected work is a frame-based work that is transcoded to a frameless work. For example, the copyright and playback management information is encoded within the selected audio frequency not usually perceived by a listener of the copyright protected work.

At block 414, the copyright and playback management information is a version number of the work. At block 415, the copyright and playback management information is no copying allowed of the work. At block 416, the copyright and playback management information is a number of copies allowed for the work. At block 417, the copyright and playback management information is a number of plays allowed for the work.

At block 420, the copyright protected frame-based work is encoded. At block 430, the encoded copyright protected frame-based work is transmitted. In one embodiment, at block 435, the encoded copyright protected frame-based work is transmitted to a device. The device decodes the embedded copyright and playback management information to facilitate in the ensuring appropriate payment of entitled copyright royalties of the copyright protected frame-based work. At block 440, appropriate payment of entitled copyright royalties of the copyright protected frame-based work is ensured based at least in part on the embedded copyright and playback management information.

### Audiovisual Work

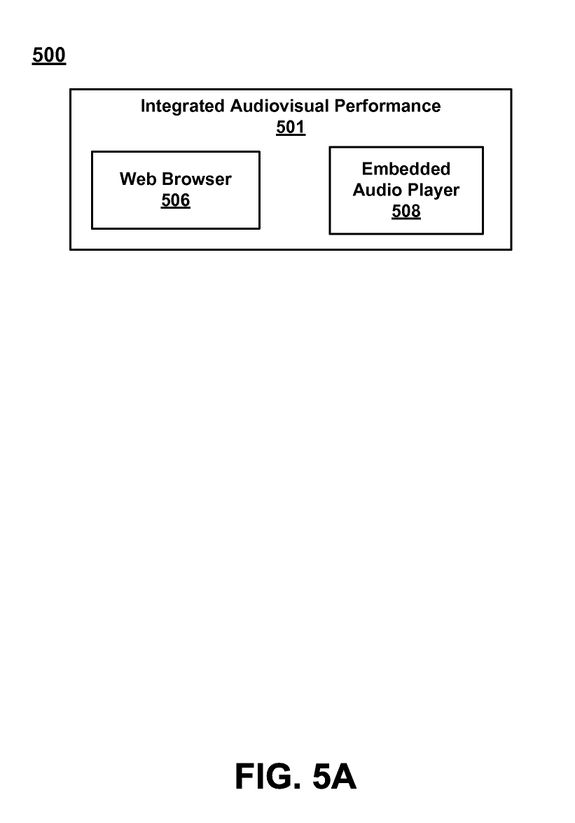

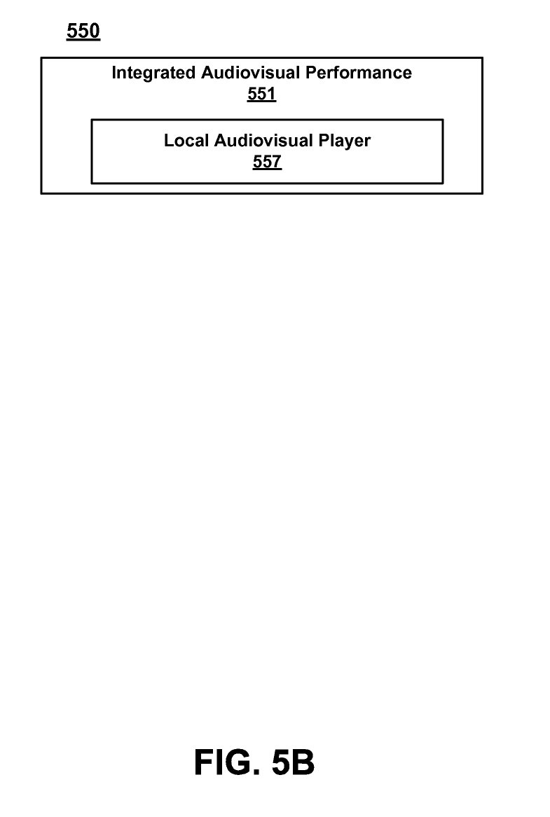

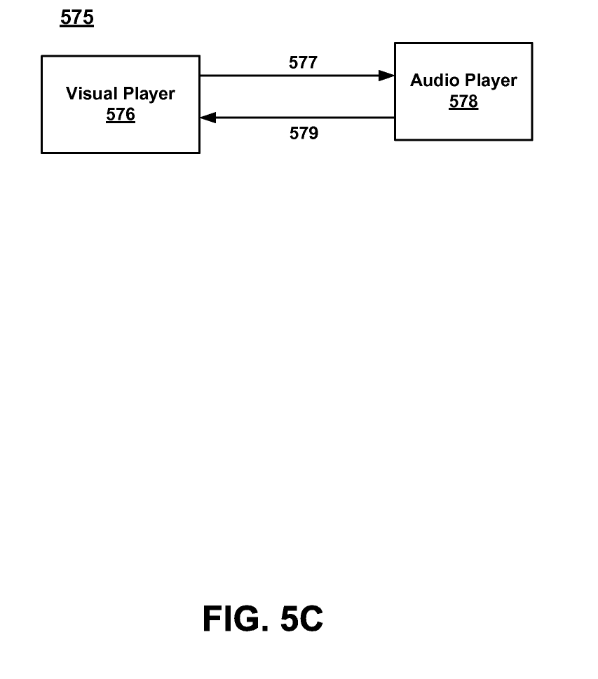

With reference now to FIGS. 5A-5C, a plurality of block diagrams 500, 550 and 575 for systems for securely providing a time and space shifted audiovisual work are shown in accordance with a number of embodiment of the present invention. In general, FIG. 5A is a block diagram of a system for securely providing a time and space shifted audiovisual work with online content in accordance with an embodiment of the present invention. Further, FIG. 5B is a block diagram of a system for securely providing a time and space shifted audiovisual work with local content in accordance with an embodiment of the present invention. Additionally, FIG. 5C is a block diagram of a system for securely providing a time and space shifted audiovisual work with a separate audio player and visual player in accordance with an embodiment of the present invention.

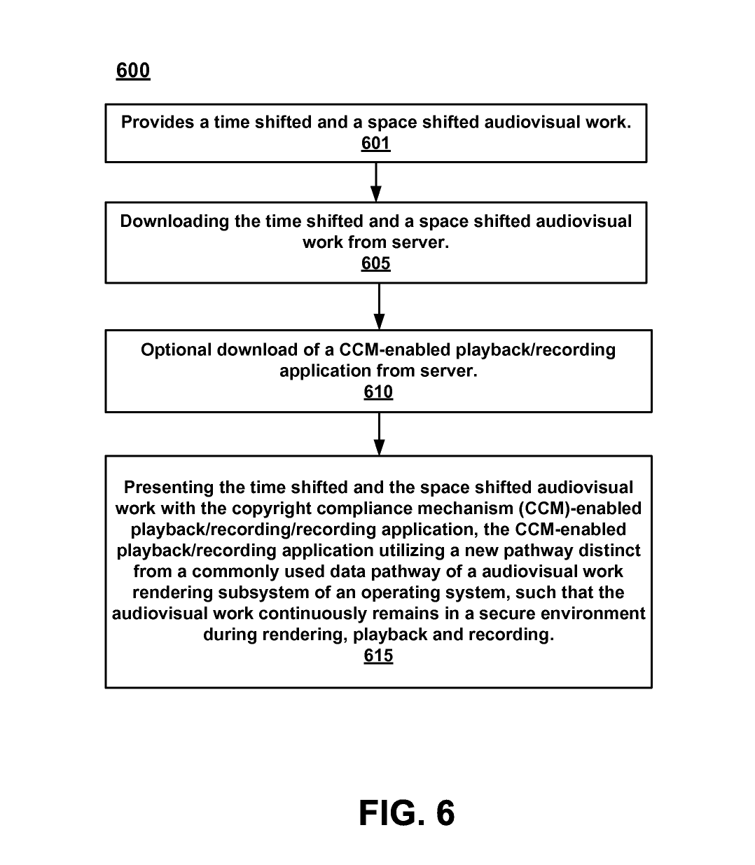

In general, the plurality of systems and techniques described herein with respect to FIGS. 5A-5C provide a few examples of the numerous different possible combinations and embodiments that may be followed in order to present the audiovisual work 307 in a secure and compliant environment. While the following embodiments are provided, it should be understood that other embodiments, including embodiment with a different number of links within an audiovisual work as well as the locations in which one or more of the portions of the audiovisual work may be stored may be greater than two. Moreover, in the following discussion, the specific operational details of systems 500, 550 and 575 are provided in the discussion of FIG. 6. Moreover, commonalities between the three systems, and numerous possible combinations of the three systems, are not repeated in each discussion for purposes of clarity.

In the present discussion, audiovisual works are considered works that consist of a series of related images which are intrinsically intended to be shown by the use of machines or devices such as projectors, viewers, or electronic equipment, together with accompanying sounds, if any, regardless of the nature of the material objects, such as films or tapes, in which the works are embodied. In addition, in the present discussion, the sounds associated with the audiovisual work do not need to be physically integrated with the series of related images, for example, a filmstrip with a separate audio cassette.

In addition, the term time shifted refers to a previously presented or generated audiovisual work such as a recording of a live broadcast. The term space shifted refers to a different location with respect to where the audiovisual work was generated in comparison to where it is being presently watched. Additionally, although in the following discussion the term link is utilized, in alternate embodiments; link may be replaced by terms such as reference, address, uniform resource locator (URL), and the like.

With reference now to FIG. 5A, an integrated audiovisual performance utilizing online content is shown. In other words, integrated audiovisual performance 501 of FIG. 5A illustrates the presentation of the audiovisual content from an online source utilizing a web browser 506 operating in conjunction with an embedded audio player 508. In one embodiment web browser 506 will present visual information include artist information, album information, images, etc., while embedded audio player 508 will simultaneously provide sound recordings or other audio content. In one embodiment, web browser 506 and audio player 508 are distinct applications. However, in another embodiment web browser 506 and audio player 508 may be concatenated into a single application such as the BlueBeat Audio/Visual Player™, or the like. In one embodiment, CCM-enabled playback/recording application 205 is utilized by both visual player 506 and audio player 508. In another embodiment, a single CCM-enabled playback/recording application 205 controls both visual player 506 and audio player 508 with respect to the presenting of audiovisual work 307.

In another embodiment, such as with respect to separate audiovisual presentations, a portion of the server providing the audiovisual presentation may include access control. In other words, the nature of the audiovisual presentation may be such that the user can freely play either the audio portion or the visual portion or parts of both portions, but will require special privileges to play the remaining portions of the presentation. Such privileges may include (but not be limited to) membership in or subscription to a particular Web site.

For example, the BlueBeat™ site could make its visual content available to registered users only, in which case a user attempting to access visual content for an audiovisual presentation using the BlueBeat™ Audiovisual Player would either need to be previously logged into the BlueBeat™ site or provide valid credentials to the site. The BlueBeat™ server would then either grant or deny access to the visual content based upon the user's registration status.

Referring now to FIG. 5B, an integrated audiovisual performance utilizing local content is shown. In other words, integrated audiovisual performance 551 of FIG. 5B illustrates the presentation of the audiovisual content from a local source utilizing a local audiovisual player 557. In one embodiment, the local audiovisual content will include visual information such as artist information, album information, images, etc., while simultaneously providing sound recordings or other audio content. In one embodiment, local audiovisual player 557 is an application such as the BlueBeat Audio/Visual Player™, or the like. In one embodiment, local audiovisual player 557 includes CCM-enabled playback/recording application 205.

With reference now to FIG. 5C, a separate audiovisual performance is shown. In FIG. 5C the content may be online, local, or a combination thereof as described in more detail in FIG. 6. However, in FIG. 5C a distinct visual player 576 is shown operating in conjunction with a separate audio player 578. In one embodiment visual player 576 may include artist information, album information, images, etc. Further, audio player 578 may include sound recordings, other audio content. Moreover, in one embodiment, when audio player 578 is accessed to present audiovisual work 307, audio player 578 will utilize communication pathway 579 to automatically launch visual player 576. Similarly, in another embodiment, when visual player 576 is accessed to present audiovisual work 307, visual player 576 will utilize communication pathway 577 to automatically launch audio player 578. In one embodiment, CCM-enabled playback/recording application 205 is utilized by both visual player 576 and audio player 578. In another embodiment, a single CCM-enabled playback/recording application 205 controls both visual player 576 and audio player 578 with respect to the presenting of audiovisual work 307.

With reference now to FIG. 6, a flowchart 600 of a method for securely providing a time and space shifted audiovisual work 307 is shown in accordance with one embodiment of the present invention.

With reference now to 601 of FIG. 6, one embodiment provides a time shifted and a space shifted audiovisual work download at a server for delivery to a local device. In one embodiment, the construction of a self-contained audiovisual work download unit containing all audiovisual information required for presentation on one or more devices capable of presenting the audiovisual work. In another embodiment, the construction of the audiovisual work includes the generation of an audio file containing embedded visual information in conjunction with links to additional visual content required for presentation of the audiovisual work 307. In yet another embodiment, the construction of the audiovisual work 307 includes the generation of a visual file containing embedded audio information in conjunction with links to additional audio content required for presentation of the audiovisual work 307.

It should be appreciated that the audiovisual work may be any frame-based audiovisual work stored in a frame-based audiovisual work database 110. In one embodiment, the frame-based audiovisual work includes sounds such as for example, MPEG-1 Audio Layer 3 (MP3) files; as well as a series of related images which are intrinsically intended to be shown together with the accompanying sounds. For example, in one embodiment, the series of related images may be selected from the group of related images including artist information, album information, artist images, related artist information and related artist images. The methods and systems described with respect to FIGS. 1-4 may then be performed on or utilized with respect to the audiovisual work 307. With respect to the series of related images intrinsically intended to be shown together with the accompanying sounds, in one embodiment, the accompanying sounds are not physically integrated with the series of related images.

Referring now to 605 of FIG. 6, a download of the presentation is received from a server to a local device. In one embodiment, the Internet is utilized to deliver the audiovisual work broadcasts. In one embodiment, the local device may be any type of electronic device capable of presenting the audiovisual work 307 such as, but not limited to, a computer system, a portable computing device, a mobile phone, PDA, MP3 player with video rendering capabilities, a television, a presentation device such as a projector, viewer or electronic equipment intrinsically coupled with an audio device such as a tape player, digital player, stereo player, and the like.

Referring now to 610 of FIG. 6, the optional download of the CCM-enabled playback/recording application 205 is received from a server to a local device. In general, the CCM-enabled playback/recording application 205 is required to render, playback or copy the audiovisual work 307. However, 610 may be optional since the local device may already have the CCM-enabled playback/recording application 205 thereon, and as such, another download of the CCM-enabled playback/recording application 205 would be unnecessary.

With reference now to 615 of FIG. 6, the presentation of the audiovisual work 307 is provided on the local device by the CCM-enabled playback/recording application. For example, one embodiment receives a first portion of the audiovisual work at a first computing device having the CCM-enabled playback/recording application 205 thereon. In addition, a link is provided within the first portion of the audiovisual work to a second portion of the audiovisual work stored on a second computing device. Moreover, in one embodiment the CCM-enabled playback/recording application 205 requires the first computing device to access both the first portion and the second portion of the audiovisual work before the audiovisual work will be accessible. In one embodiment, the first computing device utilizes a network connection to access the second portion of the audiovisual work stored on the second computing device.

In one embodiment, the first portion of the audiovisual work includes an audio file containing embedded visual information in conjunction with the link to the second portion comprising additional visual content. In another embodiment, the first portion of the audiovisual work includes a visual file containing embedded audio information in conjunction with the link to the second portion comprising additional audio content.

As stated herein, in one embodiment SCMS information is utilized in the first portion of the audiovisual work to provide the link to the second portion of the audiovisual work. In another embodiment an ID3V2 tag is utilized in the first portion of the audiovisual work to provide the link to the second portion of the audiovisual work. In yet another embodiment both the SCMS information and the ID3V2 tag may be utilized. In a further embodiment, a plurality of links may be provided.

In other words, prior to presentation of the audiovisual work 307, a portion of the SCMS information or ID3V2 tag of the downloaded file is checked to ensure that the audiovisual work 307 is capable of being presented in a standalone format, e.g., is a self-contained file, or whether the downloaded audiovisual work 307 includes a link. If a link is provided in either or both the SCMS information and the ID3V2 tag, then CCM-enabled playback/recording application will automatically access an Internet connection and receive the information from the link location prior to presenting the audiovisual work 307. Thus, in one embodiment if no Internet connection is available, then the audiovisual work 307 will not be presented by the CCM-enabled playback/recording application.

In one embodiment, the link information may be included in one or more locations of the 32 bit example provided in the discussion of FIG. 3. Further, it should also be appreciated that the ID3V2 tag may be metadata in the MP3 frame headers similar in operation to the metadata described above and with respect to FIG. 3.

In one embodiment, if the audiovisual work 307 has detectable SCMS information, but the information is either corrupt or internally inconsistent, then the CCM-enabled playback/recording application 205 would not allow presentation of the audiovisual work. For example, if the CCM-enabled playback/recording application 205 is unable to confirm that no network link is required to properly present both the audio and the intrinsically intended series of related images, then the CCM-enabled playback/recording application 205 will default to not presenting the audiovisual work 307.

### Example Computing System

Referring now to FIG. 7, a diagram of computer system 700 in accordance with one embodiment of the present invention is shown in greater detail. Within the discussions certain processes are discussed that are realized, in one embodiment, as a series of instructions that reside within computer readable memory units of system 700 and executed by processor 702 of system 700. When executed, the instructions cause the computer system 700 to perform specific functions and exhibit specific behavior as described.

In general, computer system 700 used by the embodiments of the present invention comprises an address/data bus 701 for communicating information, one or more central processors 702 coupled with the bus 701 for processing information and instructions, a computer readable volatile memory unit 703 (e.g., random access memory, static RAM, dynamic, RAM, etc.) coupled with the bus 701 for storing information and instructions for the central processor(s) 702, a computer readable non-volatile memory unit 704 (e.g., read only memory, programmable ROM, flash memory, EPROM, EEPROM, etc.) coupled with the bus 701 for storing static information and instructions for the processor(s) 702.

System 700 also includes a mass storage computer readable data storage device 705 such as a magnetic or optical disk and disk drive coupled with the bus 701 for storing information and instructions. Optionally, system 700 can include a display device 706 coupled to the bus 701 for displaying information to the computer user (e.g., maintenance technician, etc.), an alphanumeric input device 707 including alphanumeric and function keys coupled to the bus 701 for communicating information and command selections to the central processor(s) 702, a cursor control device 708 coupled to the bus for communicating user input information and command selections to the central processor(s) 702, and a signal generating input/output device 709 coupled to the bus 701 for communicating command selections to the processor(s) 702.

Examples of well known computing systems, environments, and configurations that may be suitable for use with the present technology include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

What is claimed is:

1. A method for securely providing a time and space shifted audiovisual work, said method comprising:
accessing a time shifted and a space shifted audiovisual work comprising a series of related images that are intrinsically intended to be shown with accompanying sounds; and
presenting said time shifted and said space shifted audiovisual work with a copyright compliance mechanism (CCM)-enabled playback/recording/recording application, said CCM-enabled playback/recording application utilizing a new pathway distinct from a commonly used data pathway of a audiovisual work rendering subsystem of an operating system, such that said audiovisual work continuously remains in a secure environment during rendering, playback and recording.

2. The method of claim 1 further comprising:
downloading said time shifted and said space shifted audiovisual work to a computing device having said CCM-enabled playback/recording application thereon; and
presenting said time shifted and said space shifted audiovisual work with said CCM-enabled playback/recording application on said computing device, said CCM-enabled playback/recording application on said second device utilizing a new pathway distinct from a commonly used data pathway of a audiovisual work rendering subsystem of an operating system, such that said audiovisual work continuously remains in a secure environment during rendering, playback and recording.

3. The method of claim 1 further comprising:
receiving a first portion of said audiovisual work at a first computing device having said CCM-enabled playback/recording application thereon;
providing a link within said first portion of said audiovisual work to a second portion of said audiovisual work stored on a second computing device; and
requiring said first computing device to access both said first portion and said second portion of said audiovisual work before said audiovisual work is accessible.

4. The method of claim 3 further comprising:
said first computing device utilizing a network connection to access said second portion of said audiovisual work stored on said second computing device.

5. The method of claim 3 wherein receiving said first portion of said audiovisual work comprises:
receiving an audio file containing embedded visual information in conjunction with said link to said second portion comprising additional visual content.

5. The method of claim 3 wherein receiving said first portion of said audiovisual work comprises:
receiving a visual file containing embedded audio information in conjunction with said link to said second portion comprising additional audio content.

6. The method of claim 3 further comprising:
utilizing a serial copy management system information for said first portion of said audiovisual work to provide said link to said second portion of said audiovisual work.

7. The method of claim 3 further comprising:
utilizing an ID3V2 tag in said first portion of said audiovisual work to provide said link to said second portion of said audiovisual work.

8. The method of claim 1 wherein said series of related images are selected from the group consisting of artist information, album information, artist images, related artist information and related artist images.

9. The method of claim 1 wherein said accompanying sounds are not physically integrated with said series of related images.

10. A system for secure rendering, playing and recording a time and space shifted audiovisual work comprising:
a time and space shifted audiovisual work comprising a series of related images selected from the group consisting of artist information, album information, artist images, related artist information and related artist images that are intrinsically intended to be shown with accompanying sounds, said accompanying sounds not physically integrated with said series of related images; and
a copyright compliance mechanism (CCM)-enabled playback/recording/recording application for presenting said time shifted and said space shifted audiovisual work, said CCM-enabled playback/recording application utilizing a new pathway distinct from a commonly used data pathway of a audiovisual work rendering subsystem of an operating system, such that said audiovisual work continuously remains in a secure environment during rendering, playback and recording.

11. The system of claim 10 wherein a first portion of said audiovisual work is received at a first computing device having said CCM-enabled playback/recording application thereon; said first portion including a link to a second portion of said audiovisual work stored on a second computing device; wherein access to both said first portion and said second portion of said audiovisual work is required before said audiovisual work is accessible for playback or recording on said first computing device.

12. The system of claim 11 wherein said first portion of said audiovisual work comprises an audio file containing embedded visual information in conjunction with said link to said second portion comprising additional visual content.

13. The system of claim 11 wherein said first portion of said audiovisual work comprises a visual file containing embedded audio information in conjunction with said link to said second portion comprising additional audio content.

14. The system of claim 11 wherein said link to said second portion of said audiovisual work is selected from the group consisting of: a serial copy management system information of said first portion of said audiovisual work and an ID3V2 tag in said first portion of said audiovisual work.

15. A computer readable medium having computer implementable instructions stored thereon, said instructions for causing a server to perform a method for providing secure time and space shifted audiovisual work to a computing device, said method comprising:
generating an audiovisual work comprising a series of related images that are intrinsically intended to be shown with accompanying sounds, said accompanying sounds are not physically integrated with said series of related images;
time shifting said audiovisual work;
space shifting said audiovisual work; and
providing said time shifted and said space shifted audiovisual work to said computing device having said CCM-enabled playback/recording application thereon, said CCM-enabled playback/recording application on said computing device utilizing a new pathway distinct from a commonly used data pathway of a audiovisual work rendering subsystem of an operating system, such that said audiovisual work continuously remains in a secure environment during playback and recording.

16. The computer readable medium of claim 15 further comprising:
receiving a first portion of said audiovisual work at said computing device having said CCM-enabled playback/recording application thereon;
providing a link within said first portion of said audiovisual work to a second portion of said audiovisual work stored on said server; and
requiring said computing device to access both said first portion and said second portion of said audiovisual work before said audiovisual work is accessible for playback or recording on said computing device.

17. The computer readable medium of claim 16 wherein receiving said first portion of said audiovisual work comprises:
receiving an audio file containing embedded visual information in conjunction with said link to said second portion comprising additional visual content.

18. The computer readable medium of claim 16 wherein receiving said first portion of said audiovisual work comprises:
receiving a visual file containing embedded audio information in conjunction with said link to said second portion comprising additional audio content.

19. The computer readable medium of claim 16 wherein said link to said second portion of said audiovisual work is selected from the group consisting of: a serial copy management system information of said first portion of said audiovisual work and an ID3V2 tag in said first portion of said audiovisual work.

20. The computer readable medium of claim 15 wherein said series of related images are selected from the group consisting of artist information, album information, artist images, related artist information and related artist images.
